(19) United States
(12) Patent Application Publication
(10) Pub. No.: US 2014/0096721 A1
(43) Pub. Date: Apr. 10, 2014

(54) MULTIPLE FUNCTION ANIMAL LEASH

(71) Applicant: Stephanie MILLARD, Jim Thorpe, PA (US)

(72) Inventor: Stephanie MILLARD, Jim Thorpe, PA (US)

(21) Appl. No.: 14/014,781

(22) Filed: Aug. 30, 2013

Related U.S. Application Data
(60) Provisional application No. 61/695,031, filed on Aug. 30, 2012.

(51) Int. Cl. A01K 27/00

(52) U.S. Cl. CPC A01K 27/001; A01K 27/003
USPC 119/792

(57) ABSTRACT

A multiple function animal leash made of a single length of leash material having two identical ends, each of which can serve as an adjustable collar, an adjustable collar connector, and as an adjustable leash handle, and which can be used as a leash for a single animal or as a leash for two animals. A comfort grip or handle is generally located at or near the centerpoint of the leash body.

This application claims priority under 35 U.S.C. §119(e) from U.S. Provisional Application Ser. No. 61/695,031 entitled “Dual-Function Animal Leash,” filed on Aug. 30, 2012, and which is incorporated herein by reference in its entirety.

### FIELD OF THE INVENTION

The present invention relates to leashes and collars for animals.

### BACKGROUND OF THE INVENTION

There are many known types of animal leashes and collars, but there is no article that having two identical ends, each of which can server as an adjustable collar, an adjustable collar connector, and as an adjustable leash handle and which can be used as a leash for a single animal or as a leash for two animals.

### SUMMARY OF THE INVENTION

The present invention is a multiple function animal leash which, according to a preferred embodiment, is made of a single length of leash materials having two identical ends, each of which can serve as an adjustable collar, an adjustable collar connector, and as an adjustable leash handle, and which can be used as a leash for a single animal or as a leash for two animals.

According to an embodiment of the invention, a multi-function animal leash consists of a single length of leash material having a first end, a second end, and a center region; a first set of hardware located proximate to said first end, configured to form a first portion of said length of leash material into a first adjustable loop; a second set of hardware located proximate to said second end, configured to form a second portion of said length of leash material into a second adjustable loop; wherein said first and second adjustable loops are at opposite ends of said single length of leash material.

According to a further embodiment of the invention, said first and second sets of hardware each include hardware selected from the group consisting of buckles, clips, and rings.

According to another embodiment of the invention, the first and second sets of hardware each include a side release buckle set having a male part and a female part.

According to another embodiment of the invention, one of said male part and said female part for each of said side release buckle sets is fixedly attached at an end of said length of leash material and another of said male part and female part for each of said side release buckle sets is slidably attached to said length of leash material.

According to another embodiment of the invention each of said sets of hardware further comprises a triglide slidably engaged on said length of leash material.

According to another embodiment of the invention, the multi-function leash may include a comfort handle or “grip” attached to said length of leash material at or near said center region.

According to various embodiments of the invention, each of said first and second loops can each and independently be configured to serve as an animal collar, an animal collar attachment, a handle, a post loop, and a tree loop.

### DESCRIPTION OF THE DRAWINGS

The subsequent description of the preferred embodiments of the present invention refers to the attached drawings, wherein:

FIG. 1 is a perspective illustration of a multiple function leash according to the invention.

FIG. 2 is a close-up illustration of one side of a multiple function leash according to the invention.

FIG. 3 is a top view of the male end of a side release buckle according to an embodiment of the invention.

FIG. 4 is an underside perspective view of a male end of a side release buckle according to an embodiment of the invention.

FIG. 5 is a top perspective view of a triglide according to an embodiment of the invention.

FIG. 6 is a top view of a triglide threaded onto a length of animal leash according to an embodiment of the invention.

FIG. 7 is a bottom view of a triglide threaded onto a length of animal leash according to an embodiment of the invention.

FIG. 8 is a perspective view of one end of a length of animal leash threaded through the female end of a side release buckle and stitched back on itself, according to an embodiment of the invention.

FIG. 9 is a close-up view of one end of a length of animal leash stitched back onto itself according to an embodiment of the invention.

FIG. 10 is a top view of a handle attached to a center portion of an animal leash according to an embodiment of the invention.

FIG. 11 is a side view of a handle attached at each end to a center portion of a leash according to one embodiment of the invention.

### DETAILED DESCRIPTION OF THE INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

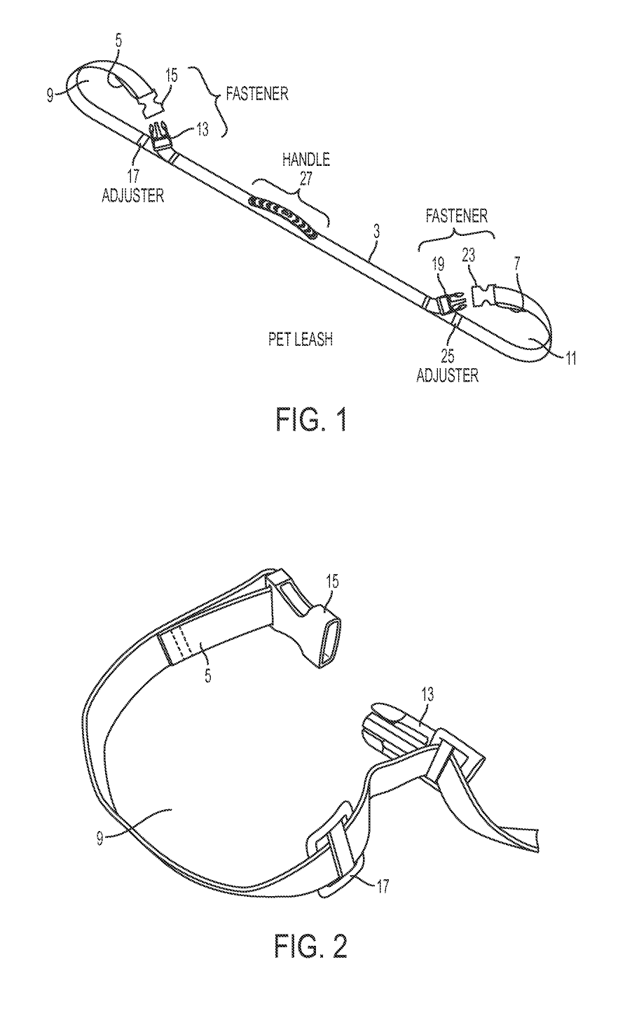

FIG. 1 shows a multiple function animal leash according to a preferred embodiment of the invention. The leash shown in FIG. 1 is a single length of leash material (“leash body”) 3 having two ends 5, 7. Each end is fitted with hardware that allows an end of the leash to be attached back on itself to form an adjustable loop, 9, 11, which may serve as a collar, collar attachment, or handle. Each end is also preferably fitted with hardware that allows the loop at each end to be adjusted in size.

According to a preferred embodiment, the hardware used to form each end of the length of leash material into a loop may include side release buckles. Referring to FIG. 1, end 5 of the leash material 3 is threaded through the male side 13 of a side release buckle, through a triglide 17 or other slidable adjustment element, through the female side 15 of a side release buckle. The end 5 of the leash material 3 may then be stitched or otherwise attached to itself a short distance from its interface with the female side 15 of the side release buckle. In order to form loop 9 (whether for a collar or a handle or other use), the female 15 and male parts 13 of the side release buckle are mated to one-another. The size of the loop 9 may be adjusted by threading the length of leash material 3 in one direction or the other through the tail end of the male side release buckle part 13. Triglide 17 may be moved adjacent to male side 13 of the side release buckle to prevent the male side 13 from unintentionally moving along the length of leash material 3 in the direction of the female end 15, thereby causing the loop to constrict. Another triglide (not shown) may be located at the other side of the male side 13 of the side release buckle to prevent male side 13 of the side release buckle from unintentionally moving in the other direction along the leash, as well.

The other end of the leash may be fitted with hardware in the same fashion. The opposite end 7 of the leash material 3 is threaded through the male side 19 of a side release buckle, through a triglide 25 or other slidable adjustment element, through the female side 23 of a side release buckle. The end 7 of the leash material 3 may then be stitched or otherwise attached to itself a short distance from its interface with the female side 23 of the side release buckle. In order to form loop 11 (whether for a collar or a handle or other use), the female 23 and male parts 19 of the side release buckle are mated to one-another. The size of the loop 11 may be adjusted by threading the length of leash material 3 in one direction or the other through the tail end of the male side release buckle part 19. Triglide 25 may be moved adjacent to male side 19 of the side release buckle to prevent the male side 19 from unintentionally moving along the length of leash material 3 in the direction of the female end 23, thereby causing the loop to constrict. Another triglide (not shown) may be located at the other side of the male side 19 of the side release buckle to prevent male side 19 of the side release buckle from unintentionally moving in the other direction along the leash, as well.

FIG. 2 is a close-up of loop 9, including male 13 and female 15 parts of a side release buckle and triglide 17. FIG. 2 shows how the size of loop 9 may be adjusted by sliding male part 13 along the length of leash material, and how triglide 17 can be moved adjacent to male part 13 to prevent it from unintentionally moving along the length of leash material 3 toward female part 15. Loop 11 may be configured in the same way.

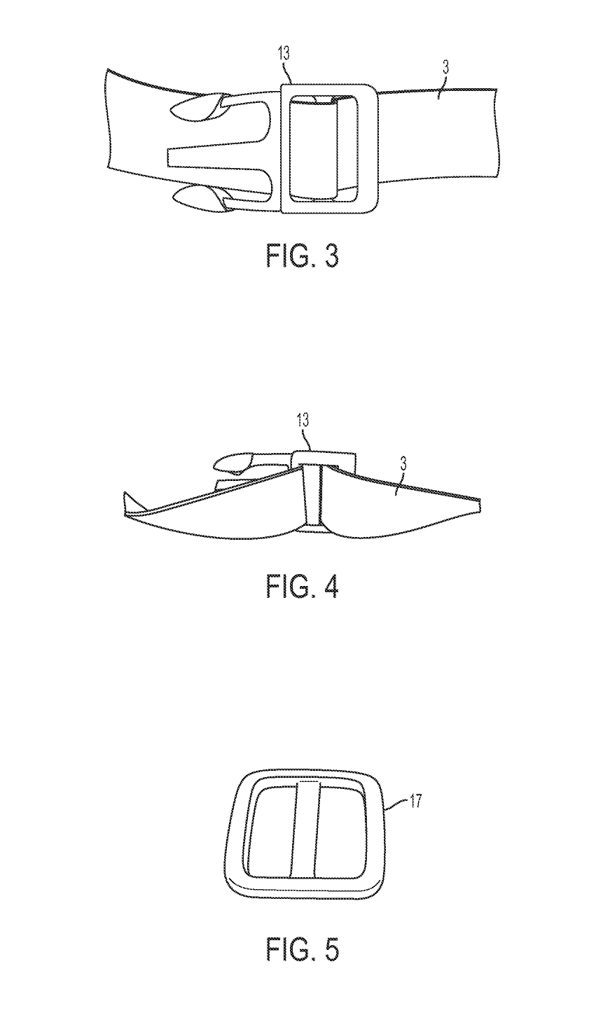

FIGS. 3 and 4 show close-up views of the length of leash material 3 threaded through the back end of the male part 13 of a side release buckle.

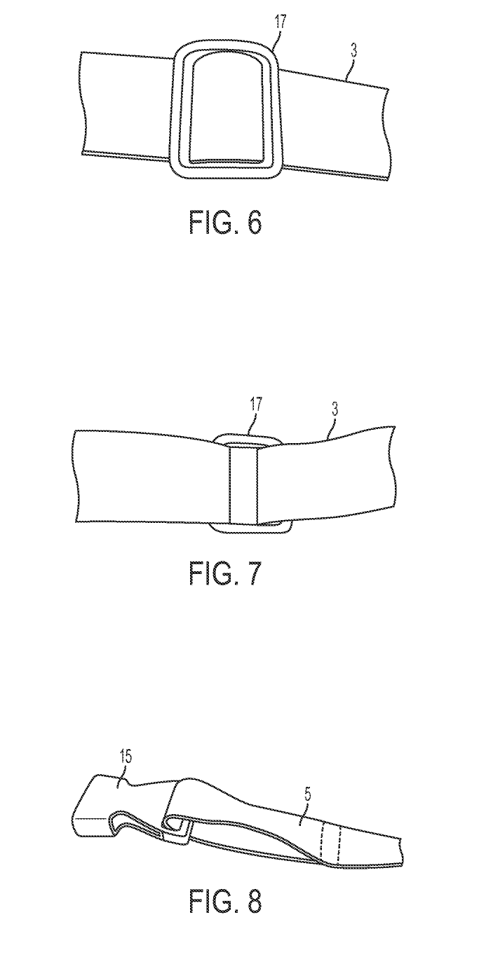

FIG. 5 shows a close-up of a triglide 17 according to an embodiment of the invention, and FIGS. 6 and 7 show close-up views of triglide 17 threaded over length of leash material 3.

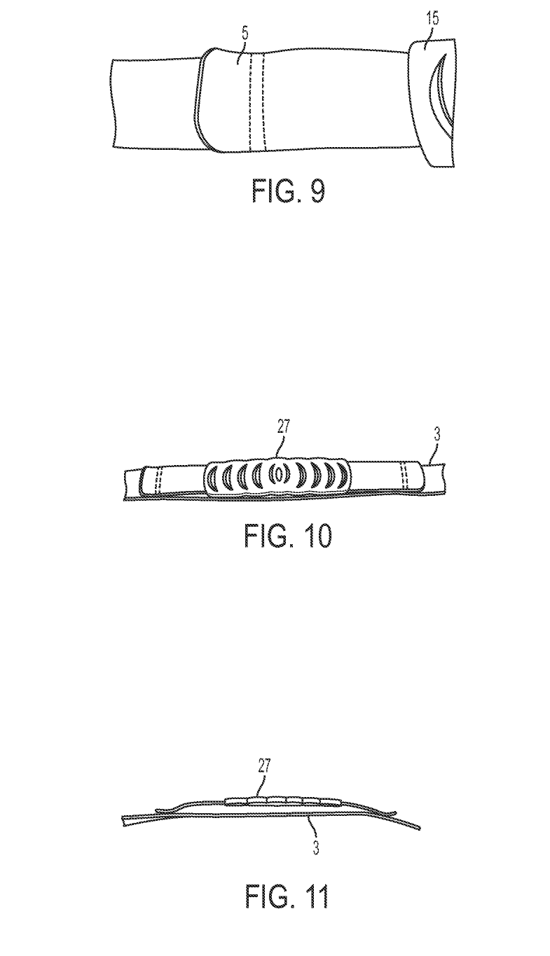

FIG. 8 shows a close-up of end 5 of leash material threaded through the back end of female part 15 of a side release buckle and attached to itself. FIG. 9 shows an embodiment of the invention where end 5 of leash material 3 is attached to itself by stitching.

Referring back to FIG. 1, an embodiment of the multiple function animal leash of the invention includes a central handle or comfort grip 27, generally located at or near the midpoint of the length of leash material 3. Grip 27 may be made of the same or different material as the length of leash material, and may optionally be made of or be fitted with materials, for example, rubber, foam, gel, sheepskin, etc., adapted to the comfort of the person using the device. According to the embodiment shown in FIG. 1, comfort grip 27 may be a length of material from 6 inches to 24 inches long, attached to the length of leash material.

FIG. 9 shows an end of comfort grip 27 stitched to the length of leash material 3. FIGS. 10 and 11 show an embodiment according to which grip 27 is configured to generally lay flat against the length of leash material 3, attached at each end to the length of leash material by stitching.

According to various uses of the animal leash of the invention, a user may manage two animals by fastening loops 9 and 11 around each animal's neck, respectively. The user can then walk and/or manage both animals by holding comfort grip/handle 27.

According to a different use, loop 9 may be fastened around one animal's neck, and loop 11 may be fastened through the collar of another animal.

According to yet another use, loop 9 may be either fastened around one animal's neck, or through the animal's collar, and the user may use the other loop 11 as an alternative handle, optionally holding loop 11 in one hand and handle 27 in the other hand for maximum control.

According to another use, loop 9 may be fastened around an animal's neck or through an animal's collar, and loop 11 may be slipped over a post. If the post is very tall or very wide, loop 11 may be opened by disconnecting the male and female ends of the fastener, adjusted to an appropriate size, and then connected around the post (or tree, column, pipe, etc.).

Persons of ordinary skill will appreciate that the female and male parts of the side release buckle disclosed herein may be readily switched with one another (the female part located where the male part is described, and vice-versa) or replaced altogether with other closeable and or mating structures without departing from the object of the invention. Various types of closable and/or mating structures are known, and they are considered to fall within the scope of the invention. By way of non-limiting example, either of the male or female side of the side release buckle may be replaced with a ring, and the other side may be replaced, for example, with a leash clip or snap bolt, spring clip, tag clip, trigger snap, lobster claw, or other device.

Likewise, the leash body may be made of any material suitable for a pet leash, but the most preferred material is traditional nylon and nylon webbing.

1. A multi-function animal leash comprising:
a single length of leash material having a first end, a second end, and a center region;
a first set of hardware located proximate to said first end, configured to form a first portion of said length of leash material into a first adjustable loop;
a second set of hardware located proximate to said second end, configured to form a second portion of said length of leash material into a second adjustable loop;
wherein said first and second adjustable loops are at opposite ends of said single length of leash material.

2. A multi-function animal leash according to claim 1, wherein said first and second sets of hardware each comprise hardware selected from the group consisting of buckles, clips, and rings.

3. A multi-function animal leash according to claim 2, wherein said first and second sets of hardware each comprise a side release buckle set having a male part and a female part.

4. A multi-function animal leash according to claim 3, wherein one of said male part and said female part for each of said side release buckle sets is fixedly attached at an end of said length of leash material and another of said male part and female part for each of said side release buckle sets is slidably attached to said length of leash material.

5. A multi-function animal leash according to claim 4, wherein each of said sets of hardware further comprises a triglide slidably engaged on said length of leash material.

6. A multi-function animal leash according to claim 1, further comprising a handle attached to said length of leash material at or near said center region.

7. A multi-function animal leash according to claim 1, wherein each of said first and second loops can each and independently be configured to serve as an animal collar, an animal collar attachment, a handle, a post loop, and a tree loop.
